(19) United States
(12) Patent Application Publication
(10) Pub. No.: US 2013/0215152 A1
(43) Pub. Date: Aug. 22, 2013

(54) PATTERN SUPERIMPOSITION FOR PROVIDING VISUAL HARMONICS

(71) Applicant: John G. Gibbon, La Crescenta, CA (US)

(72) Inventor: John G. Gibbon, La Crescenta, CA (US)

(21) Appl. No.: 13/769,115

(22) Filed: Feb. 15, 2013

Related U.S. Application Data
(60) Provisional application No. 61/600,531, filed on Feb. 17, 2012.

(51) Int. Cl. G06T 11/60

(52) U.S. Cl. CPC G06T 11/60
USPC 345/641

(57) ABSTRACT

A system and method for superimposing tiling patterns in response to a user input or other stimuli is described. Such superimpositions provide aesthetically pleasing patterns that can be used in a variety of decorative ways. Also described is a system and method for generating superimposed patterns in response to a stimuli, such as a spoken word or sound, music, or other stimulus to automatically generate superimposed patterns, or to select superimposed patterns from a database to display and in such a manner as to provide a visual display representing the stimuli.

### BACKGROUND

The invention is directed to the field of pattern generation, and more specifically, the generation of patterns in response to stimuli received as an input to a pattern generation program.

Fitting together a variety of geometric shapes so that they form pleasing designs is a process that has historically been used to cover a surface, such as a floor, wall or other structure. Examples of the usage of such patterns can be found in ornate mosaic floors, rugs, wall coverings and the like.

Various systems have been used to identify such patterns, generally known as tilings or tessellations. A tiling is a pattern formed from one or more shapes which are arranged in such a manner that the edges of the shapes fit together over a region without any gap or overlapping of the patterns. When such tilings repeat themselves over the Euclidan Plane, they are known as periodic tilings.

The simplest tilings use basic shapes, such as triangles, squares and circles. More complex tilings include polygons of various numbers of sides greater than four.

It has long been known that regular polygons of various sides may be placed next to one another to form patterns varying from the simple to extremely complex. Such patterns have been found to be aesthetically pleasing, but have been difficult to generate without the use of specially programmed computers. Even using such computers, the generation of such superimpositions requires a great deal of time.

What has been needed, and heretofore unavailable, is a system and method for generating superimposed tilings in response to stimuli that results in the generation of such tilings in rapid and computationally efficient manner. Superimposed tiling patterns generated in this manner would be aesthetically pleasing, and could also be generated in response to music or other stimuli. Such a system and method would also be able to encode a tiling pattern to a particular stimulus such as a sound or phoneme, so that a unique tiling pattern could be generated for each encoded sound or phoneme, thus providing a visual “language”. Such a language could be useful in providing a way of communicating to persons having hearing or other learning disabilities. The present invention satisfies these, and other needs.

### SUMMARY OF THE INVENTION

In its various aspects, the present invention includes a system and method for generating superimposition of tiling patterns in response to user inputs. Such patterns are aesthetically pleasing, and may be utilized for a variety of decorative purposes.

In another aspect, the superimposed patterns may be generated in response to an input or stimuli such as, for example, a spoken word, a musical note and the like. In this manner the various aspects of the present invention may be used to visually display language, music and the like.

In another aspect, the present invention includes a system for generating superimposed patterns, comprising: a processor, responsive to input from a user, programmed using appropriate hardware and software commands, to: generate a first pattern having a plurality of elements from the user's input, generate a second pattern having a plurality of second elements from the user's input, determine a first center point representing a selected axis of rotation of a first element of the first pattern, determine a second center point representing the same axis of rotation of an adjacent element of the first pattern, calculate an inter axial distance for the for first pattern from the first and second center points of the first pattern, determine a first center point representing a selected axis of rotation of a first element of the second pattern, determine a second center point representing the same axis of rotation of an adjacent element of the second pattern, calculate an inter axial distance for the for second pattern from the first and second center points of the second pattern, align the first center point of the second pattern with the first center point of the first pattern, rotate at least one of the first pattern and the second pattern such that a line joining the first and second center points of the second pattern overlaps a line joining the first and second center points of the first pattern, scale at least one of the first and second patterns such that the inter axial distance of the first pattern is substantially equal to the inter axial distance of the second pattern, and produce an output representing the superposition of the first and second patterns.

In one alternative aspect, the second pattern is the same pattern as the first pattern, but displaced by a selected value. In yet another alternative aspect, the second pattern is the same pattern as the first pattern, but rotated in relation to the first pattern by a selected amount.

In still another aspect, the processor is also programmed to: select, in response to input from the user, a sub-pattern of either the first or second patterns, and superimpose that sub-pattern on a selected one or both of the first and second patterns.

In yet another aspect, the processor is further programmed to respond to a user input to generate at least one superimposed pattern. In still another aspect, the processor is further programmed to respond to a user input to select a superimposed pattern from the data base of superimposed patterns and output the superimposed pattern. In one alternative aspect, the input is a sound; in another alternative aspect, the input is music, and in still another aspect, the input is speech.

In an alternative aspect, the presenting invention includes a method for superimposing tiling patterns in response to a user input, comprising: generating a first pattern having a plurality of elements from the user's input; generating a second pattern having a plurality of second elements from the user's input; determining a first center point representing a selected axis of rotation of a first element of the first pattern; determining a second center point representing the same axis of rotation as that selected for the first element of an adjacent element of the first pattern; calculating an inter axial distance for the for first pattern from the first and second center points of the first pattern; determining a first center point representing a selected axis of rotation of a first element of the second pattern; determining a second center point representing the same axis of rotation as that selected for the first element of the second pattern of an adjacent element of the second pattern; calculating an inter axial distance for the for second pattern from the first and second center points of the second pattern; aligning the first center point of the second pattern with the first center point of the first pattern; rotating at least one of the first pattern and the second pattern such that a line joining the first and second center points of the second pattern overlaps a line joining the first and second center points of the first pattern; scaling at least one of the first and second patterns such that the inter axial distance of the first pattern is substantially equal to the inter axial distance of the second pattern; and producing an output representing the superposition of the first and second patterns. In one alternative aspect, the user's input includes selecting a symmetry system to be used for generating the first or second patterns. In still another alternative aspect, the user's input includes selecting a shape and orientation of the repeating elements of the pattern to be generated.

In still another aspect, the invention includes a method for superimposing periodic patterns of repeating elements in response to a user input, comprising: selecting a symmetry system to be used to generate a first pattern of repeating elements; specifying a shape and orientation of the repeating elements of the first pattern; generating the first pattern; selecting a symmetry system to be used to generate a second pattern of repeating elements; specifying a shape and orientation of the repeating elements of the second pattern; generating the second pattern; determining a first center point representing a selected axis of rotation of a first element of the first pattern; determining a second center point representing the same axis of rotation of an adjacent element of the first pattern as that selected for the first element of the first pattern; calculating an inter axial distance for the for first pattern from the first and second center points of the first pattern; determining a first center point representing a selected axis of rotation of a first element of the second pattern; determining a second center point representing the same axis of rotation of an adjacent element of the second pattern as that selected for the first element of the second pattern; calculating an inter axial distance for the for second pattern from the first and second center points of the second pattern; aligning the first center point of the second pattern with the first center point of the first pattern; rotating at least one of the first pattern and the second pattern such that a line joining the first and second center points of the second pattern overlaps a line joining the first and second center points of the first pattern; scaling at least one of the first and second patterns such that the inter axial distance of the first pattern is substantially equal to the inter axial distance of the second pattern; and producing an output representing the superposition of the first and second patterns.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 a schematic diagram showing the various computers, clients and servers of a system in accordance with various embodiments of the present invention.

FIG. 2 is a graphic representation of a tiling pattern using a *4,4,2 symmetry system, as described using orbifold notation.

FIG. 3 is a graphical representation of the combined tiling wherein two uniform tiling patterns have been combined in accordance with one embodiment of the present invention.

FIG. 4 is a block diagram of an embodiment of the method of the present invention that may be used to superposition two uniform tiling patterns to produce the tiling pattern of FIG. 3.

FIG. 5 is a graphical representation of a tiling pattern formed by superimposing a pair of ingredient tiling patterns utilizing the embodiment of the method of FIG. 4.

FIG. 6 is a graphical representation of a tiling pattern forming a first ingredient of the superimposed tiling pattern of FIG. 5 and of FIG. 8.

FIG. 7 is a graphical representation of a tiling pattern forming a second ingredient of the superimposed tiling pattern of FIG. 5.

FIG. 8 is a graphical representation of another tiling pattern formed by superimposing a pair of ingredient tiling patterns utilizing the embodiment of the method of FIG. 4.

FIG. 9 is a graphical representation of a tiling pattern forming a second ingredient of the superimposed tiling pattern of FIG. 8.

FIGS. 10-21 are graphical examples of superimpositions of patterns illustrating the various embodiments of the invention.

### DETAILED DESCRIPTION OF THE PREFERRED EMBODIMENTS

In general, the various embodiments of the present invention are directed to systems and methods for generating one or more tiling patterns in response to given stimuli, and then, where two or more tiling patterns have been generated, superimposing the two or more tiling patterns upon each other to construct various combinations of patterns that may harmoniously merge, blend or interpenetrate each other.

Harmony in image formation results from a balance between sameness and difference, or between familiarity and novelty. In the case where the patterns have too much sameness, monotony results, whereas too little sameness evokes confusion and an impression of chaos.

Visual Harmonics, in which the general principles of the various embodiments of the invention are embodied, is a process of sorting and/or creating visual images, and formatting them in such a way that they lend themselves to harmonious transition from one image to another, or alternatively to mergings or super impositions of two or more images into a harmonious new whole. These principles can be applied to still images or to animations, and be silent or accompanied by music which can be synchronized to the images to a greater or lesser degree. To some degree the system has been developed by examining analogies with conventional music, and in particular in seeking a structure analogous to the role that scale plays in aural music. The various embodiments of the present invention act as a filter keeping out all images that are not compatible with the chosen format, much as a scale effectively only allows certain ingredients to become integrated in a piece of music while all others are banished as being “out of tune.” A scale usually consists of a sequence of notes that bear something in common, such as overtones, or share an equal interval between them. In all cases a scale incorporates an acceptable balance between sameness and difference.

In the case of visual images, however, no such criterion for compatibility has existed up to now. However if restricted to periodic repeating tilings, an axis of rotational symmetry may be identified in most of those repeating tilings, and with appropriate adjustments ensure that these rotational axis coincide with each other when superimposed.

Any periodic tiling necessarily belongs to one of 17 different symmetry systems, and the first task in attempting to use existing tilings is to determine to which symmetry system each one belongs. Once the symmetry system is determined, the center of the two tiling patterns is determined by choosing which rotational axis of symmetry should be regarded as the local axis of origin. The patterns are then rotated relative to each other and the size of the patterns is adjusted so as to make the inter axial distance of the centers of rotational symmetry of the two patterns substantially equal and to align the boundaries of the pattern in a desired manner. This formatting of the patterns is done so that they coincide in such a way that their axes of rotation are perceived in the same position. This facilitates the brain's power of pattern recognition by requiring no readjustment from one image to the next. It is not necessary that the axis is represented by in intersection or being the center of some shape, but only that it remains in the same position with regard to the brain's perception In fact, when formatting reconciliation between different symmetry systems', axes of different rotational symmetries can be superimposed. This is because 6 fold symmetry encompasses within itself 3 fold and 2 fold symmetry axes, and 4 fold incorporates 2 fold. These factors are in part what differentiates the symmetry systems, but also that allows for common factors between them so that they can be harmoniously formatted.

Of the 17 possible symmetry systems, five of them require a hexagonal lattice while three require a square lattice. None of these allow any variability in the shape of the lattice. When any two axes are superimposed all the others automatically fall into place too. The remaining lattices use rectangles, squares or rhombuses which require further definition before having a precisely defined shape. However these systems can be brought into conformity with the original hexagonal and square lattices by choosing, in the case of rhombuses, angles of 60 degrees or 90 degrees, and in the case of rectangles, proportions of 1:1 (square) or 1:root 3 (1:1.732) for compatibility with hexagonal lattices. The two lattices with parallelograms can be formatted as squares or root 3 rectangles. This allows 14 of the 17 symmetry systems to be harmoniously formatted in a compatible form on a hexagonal lattice, and 12 of the 17 can be formatted on a square lattice. What is required is that the format to be used for the tiling is precisely specified. This does not preclude utilizing other proportions of rectangles rhombuses and parallelograms, but their compatibility will be restricted to other tiling patterns utilizing the same proportions.

In seeking images that blend harmoniously, the process may either begin with separate images that are compatible and formatted correctly, or the process can start with a single complex image and dismember it into component parts which can then be selectively reassembled into composite images.

The present invention may be implemented by computers organized in a conventional distributed processing system architecture. The architecture for and procedures to implement this invention, however, are not conventional, because they bridge multiple remote information sources, such as a legacy computer application (e.g., CRS) and an HTML-based Internet application, at the client workstation.

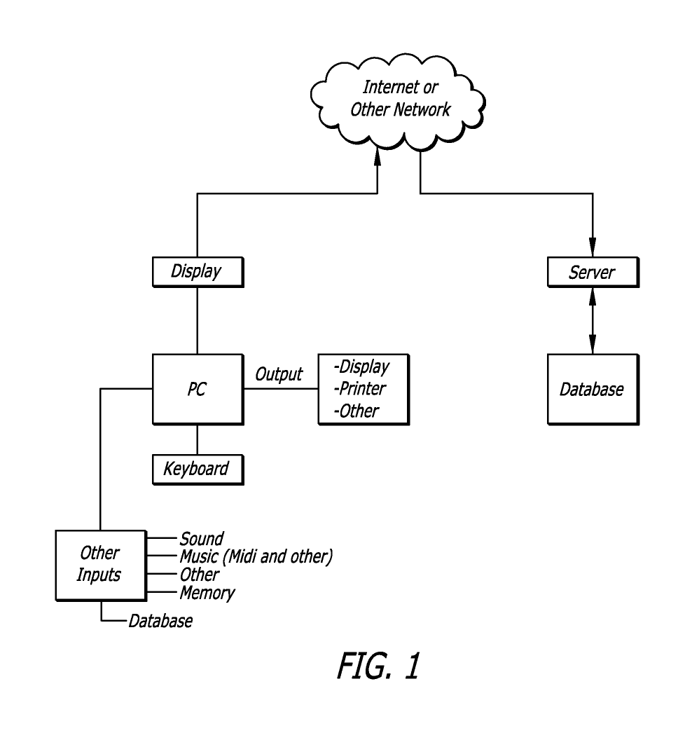

FIG. 1 is a graphical representation that illustrates an exemplary system 10 upon which an embodiment of the invention may be implemented. The various embodiments of the present invention can be implemented on a single properly programed computer 15, which may be a personal computer, or other system having a processor configured to carry out specific programming commands, a memory 20, a display 25, and a keyboard 30 or other input device known by those skilled in the art. Such a computer includes a bus or other communication mechanism for communicating information, the processor coupled with bus for processing information. The computer also includes main memory 20, such as a random access memory (RAM) or other dynamic storage device, coupled to the bus for storing information and instructions to be executed by the processor . RAM also may be used for storing temporary variables or other intermediate information during execution of instructions to be executed by the processor . The computer may further include a read only memory (ROM) or other static storage device coupled to the bus for storing static information and instructions for the processor . Additionally, a storage device (not shown), such as a magnetic disk or optical disk, may be provided and coupled to the bus for storing information and instructions.

The computer may be coupled via the bus to the display 25, such as a cathode ray tube (CRT), flat panel, or other type of display for displaying information to a computer user. An input device, such as, for example, but not limited to, the keyboard 30 including alphanumeric and other keys, is coupled to the bus for communicating information and command selections to the processor. Another type of user input device is a cursor control (not shown), such as a mouse, a trackball or cursor direction keys for communicating direction information and command selections to the processor and for controlling cursor movement on the display.

Instructions for operating the processor in such a way that the processor operates as a specifically programmed computer to carry out the various embodiments of the present invention may be read into main memory from another computer-readable medium, such as a storage device, which may be a memory, disc, or other type of memory known in the art. Alternatively, such program instructions may be downloaded from an external source, such as a remote server 35 that is in communication with the computer over a communications system 45, such as a wired or wireless LAN, WLAN, the Internet and the like. In some embodiments, a data base 40 containing data representing graphical depictions of various tiling patterns from various symmetry systems may be accessible by remote server 35 such that computer 15, under appropriate software control, may retrieve data representing the patterns for further processing by the computer 15 in carrying out the methods set forth below.

Execution of the sequences of instructions contained in main memory causes the processor to perform the process steps described herein. In an alternative implementation, hard-wired circuitry may be used in place of or in combination with software instructions to implement the invention. Thus implementations of the invention are not limited to any specific combination of hardware circuitry and software.

The term “computer-readable medium” as used herein refers to any media that participates in providing instructions to the processor for execution. Such a medium may take many forms, including but not limited to, non-volatile media, volatile media, and transmission media. Non-volatile media includes, for example, optical or magnetic disks, or other such storage devices. Volatile media includes dynamic memory, such as main memory. Transmission media includes coaxial cables, copper wire and fiber optics, including the wires that comprise bus. Transmission media can also take the form of acoustic waves, light waves, or any waves of the electromagnetic spectrum, such as those generated during radio-wave and infra-red data communications.

As described above, the computer also includes a communication interface coupled to the bus. The communication interface provides a two-way data communication coupling to a network link that is connected to local or wide area network, such as a LAN or the Internet 45. For example, communication interface may be an integrated services digital network (ISDN) card or a modem to provide a data communication connection to a corresponding type of telephone line. As another example, communication interface may be a local area network (LAN) card to provide a data communication connection to a compatible LAN, or alternatively, to the Internet. Wireless links may also be implemented. In any such implementation, communication interface sends and receives electrical, electromagnetic or optical signals that carry digital data streams representing various types of information.

The computer may also be connected to various output devices 50, such as television screens, projectors, printers or data storage devices. Additionally, the computer may accept input from other inputs 55. Such inputs may include, for example, a microphone 60 in communication with the processor of the computer via an appropriate hardware interface to allow electrical signals generated by sound waves to be inputted into the processor for the purpose of conversion by the processor or associated hardware and software into digital signals that may be used to control other processes carried out by the processor. Alternatively, digital or analog signals representing inputs to the process may be stored and retrieved from a memory 65 or other data storage media, or retrieved from a data base 70.

Utilizing appropriate hardware, signals representing music, such as MIDI encoded signals 75, may also be used as inputs to the system. Indeed, there is no limit to the kinds of input signals that can be inputted into the computer for use by the processer and the software of the present invention to carry out the various embodiments of the invention.

In some embodiments, the present invention includes server 35 that may be in communication with data base 40, as described above. In such a system, the various embodiments of the invention may be carried out by the user by implementing appropriate interface software present on the computer to access the server through a network, such as a LAN or the Internet. In this manner, the user may access computer processors associated with the server to run software processes on the server under the command and control of the user, including processes that may require accessing data stored in memory or a data base associated with and in communication with the server. In some embodiments, the server may include multiple servers in communication with one or more databases.

Visual Harmonics

In its most general embodiment, the present invention includes a system and method wherein a user may generate a tiling pattern, or select a tiling pattern from a library of generated tiling patterns, and, utilizing the steps set forth below, provide input to a software program running on the computer to control the computer to generate one or more tiling patterns, and then control the software to efficiently and rapidly superimpose the tiling patterns in accordance with the user's input to generate one or more tiling patterns, and then produce a combined tiling pattern utilizing the one or more tiling patterns. Such a combined tiling pattern can be used for aesthetic purposes, such as for producing rugs, textiles, wall covering and the like. In fact, these combined tiling patterns may be used for many purposes to provide aesthetic enjoyment, such as to produce moving visual patterns in response to user input, sounds, music and the like.

In the following discussion, one example of the present invention focuses on formatting the various patterns generated using the hardware and software described above to align the patterns so that the superimposition of the patterns results in a harmonious presentation.

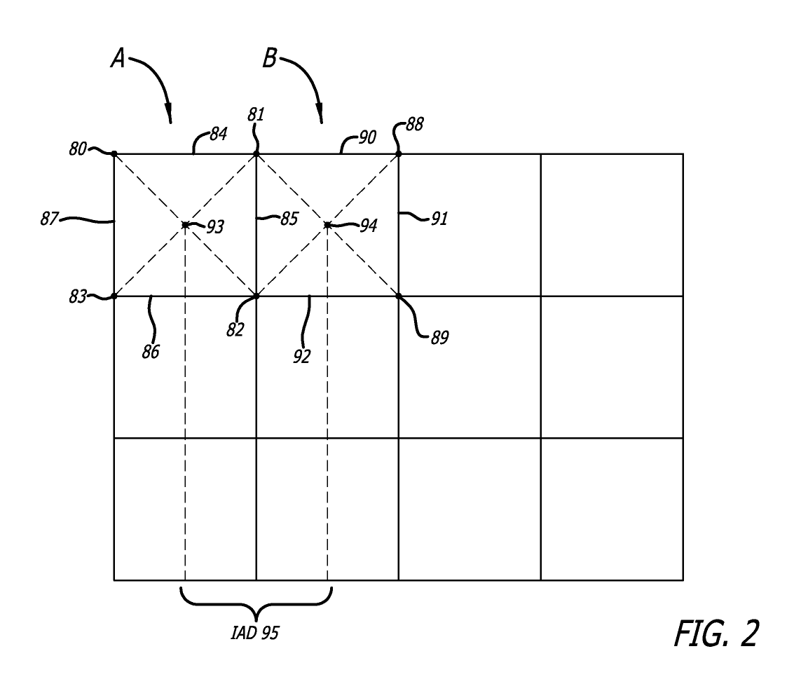

The various embodiments of the Visual Harmonics aspect of the present invention includes the ability to generate superimposition of periodic patterns by overlapping axes of rotational symmetry within a given symmetry system, and between symmetry systems. For the purpose of simplifying the following discussion, it will be understood that a periodic pattern may be thought of as a series of repeating elements, as shown in FIG. 2. FIG. 2 illustrates a periodic pattern having identified as a *4,4,2 pattern. Element A has four vertices 80, 81, 82 and 83, each vertex having four possible degrees of connectivity to another element of the pattern. Additionally, element A has four edges 84, 85, 86 and 87, each of which is connected to two of the vertices. For example, edge 84 is connected to vertex 80 and vertex 81. As also shown in FIG. 2, element B has the same symmetry as element A of the pattern. Element B shares vertices 81 and 82, and edge 85, with element B.

The generation of periodic patterns, such as that illustrated in FIG. 2, has long been known. The inventor has observed that the superimposition of additional periodic patterns on such a pattern as is illustrated in FIG. 2 produces new patterns that can be strikingly beautiful.

The various embodiments of the present invention accomplish this superimposition by formatting two or more patterns that are to be superimposed in such a manner that the patterns may be aligned and scaled so as to substantially equalize an inter axial distance (IAD) between neighboring elements of one pattern with the IAD of the pattern to be superimposed and then rotating and scaling the patterns relative to another to accomplish the superimposition.

Referring again to FIG. 2, the IAD of the illustrated pattern may be determined by determining an axis of rotation 93 for element A by drawing phantom lines from non-adjacent vertices, the axis 93 lying at the intersection of the phantom lines. Alternatively, phantom lines may be drawn from the center points of non-adjacent edges to accomplish the same determination. Axis of rotation 94 of element B is similarly determined. The IAD 95 is then the distance between axis of rotation 93 and axis of rotation 94. It will be understood that the elements of the pattern shown in FIG. 2 may be scaled by changing the length of the edges of the elements of the patterns without disturbing the symmetry of the pattern, but that such scaling would alter the IAD between two neighboring elements of the pattern in some proportion to the change in edge length of the elements.

While the above describes an embodiment where the axis of rotation, for example, axis of rotation 94, is found by determining the axis of rotation using as being the intersection of the phantom lines from non-adjacent vertices, it will also be understood that axis of rotation can be found by determining the intersection of phantom lines originating and ending at the midpoints of two opposing edges of the element. The software module that contains the programming commands that carryout the calculations necessary to determine the axis of rotation are easily modified to perform the determination using either method. In both cases, the location of the axis of rotation of an element, as determined from the coordinate universe used by the software module, is stored in the memory for later use in determining the IAD of the pattern, and for locating the starting point, as will be described further below, for further formatting of the elements of the patterns to be superimposed.

The superimposition process continues, in the simplest case of superimposition of two patterns, selecting a point of the first pattern that has the highest order or rotational symmetry of the first pattern, and using that as the starting point for the formatting process. The same process is carried out on a second pattern to be superimposed on the first pattern. The starting points of the two patterns are aligned, or pinned together by the algorithms of a software module implemented on the hardware of the computer system. The software module then manipulates the patterns in the memory of the computer system so as rotate the patterns relative to each other about the pinned starting points until a line joining the axes of rotation of two neighboring elements of the pattern being superimposed lies upon a similar line joining the axes of rotation of two neighboring elements of the first pattern. Once this rotation is completed, the edges of the superimposed pattern may be scaled so that the IAD of the superimposed pattern is substantially equal to the IAD of the first pattern. It will be understood that the rotation and scaling processes may be carried out on one pattern, as described above, or may be carried out either sequentially or simultaneously on both patterns.

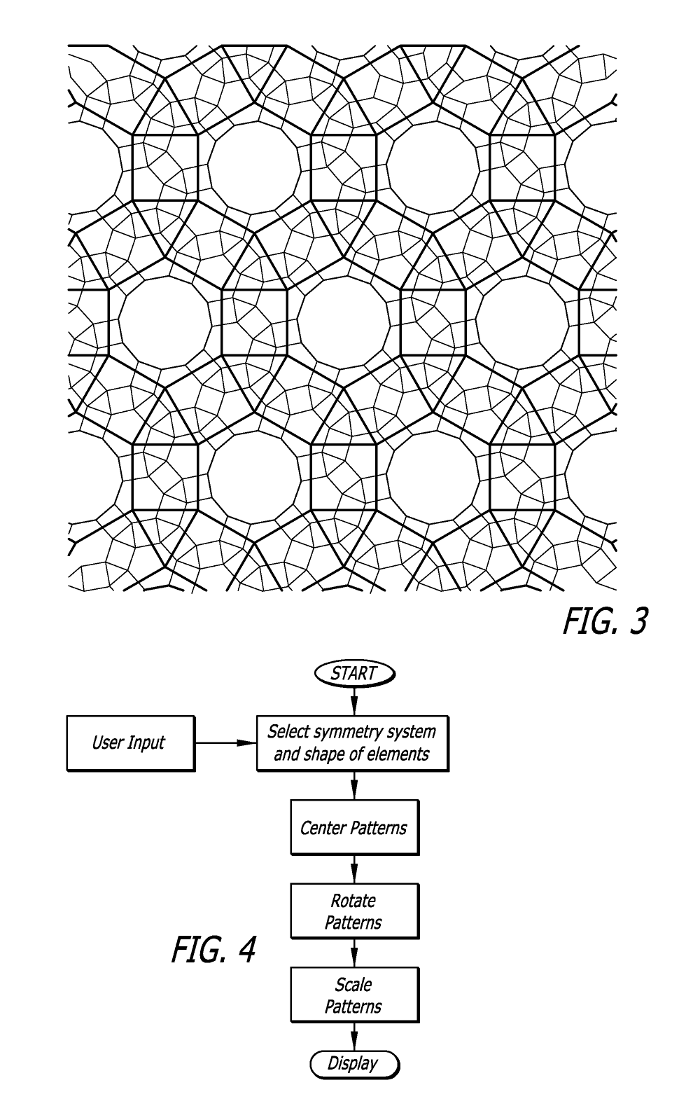

FIG. 3 is one example of a combined tiling pattern that may be produced using various embodiments of the present invention such as the process described above.

FIG. 4 is a block diagram of one embodiment of a method 100 for superimposing tiling patterns in accordance with principles of the present invention. The exemplary processes and steps set forth in relation to FIG. 4 are embodied in computer software that includes programming commands for programming the processor of either the computer accessed by the user, or the server, or any other processors in communication with the user's systems for carrying out the various embodiments of the invention.

In one embodiment, for example, the software programming is operative to program a processor residing on the server to carry out the invention. In such an embodiment, the user initiates a communication session with the server, using standard techniques and protocols known to those skilled in the art, and controls the operation of the program by inputting commands to the computer which would then be communicated to the processor of the server. Alternatively, all of the procession could be carried out locally by the processor of the computer.

In another embodiment, the database associated with the server may include a library of pre-generated tiling patterns that may be accessed by the server, and thus the user, when the user is in communication with the server.

The process of FIG. 4 begins with user input at box 105. The user inputs commands to select a starting criteria, such as a symmetry system to be used. For a discussion of symmetry systems, see “Honours Project” Things and Patterns, by Ng Lay Ling, Department of Mathematics, National University of Singapore, 2003/2004 Semester 1, incorporated herein in its entirety by reference.

Besides selecting the symmetry system to be used, the user may also select one or more images or tiling patterns to be superimposed at box 110. Other inputs may also be made at this point, such as various ratios to be used to ensure superimposition of the various selected patterns, including input related to sizing, orientation of the patterns in relation to each other, relative displacement between superimposed images or patterns, and the like.

In box 115, the processor, under control of the various software commands embodying the invention, analyzes the images or patterns to be superimposed to determine a starting axis of rotation and IAD for each pattern. The starting axes of rotation for each pattern are then aligned in such a manner that the patterns are centered so that the starting axes of rotation of the patterns overlap.

The software then controls a process wherein the patterns are rotated in relation to each other so as to align the patterns in box 120 so that a line joining the axes of rotation of two neighboring elements of each pattern are superimposed. Depending on the design input of the user, the length of the edges of one of the patterns is scaled in box 125 so that the IAD of each pattern is substantially equal, or at the least, is minimized within parameters provided by the user input to produce a desired superimposition. In some embodiments, a library of pre-formatted patterns may be stored; this simplifies the procedure by allowing use of the pre-formatted patterns to create the superimposed images.

After the scaling process is completed, the combined image is displayed, printed, stored, or otherwise outputted in box 130.

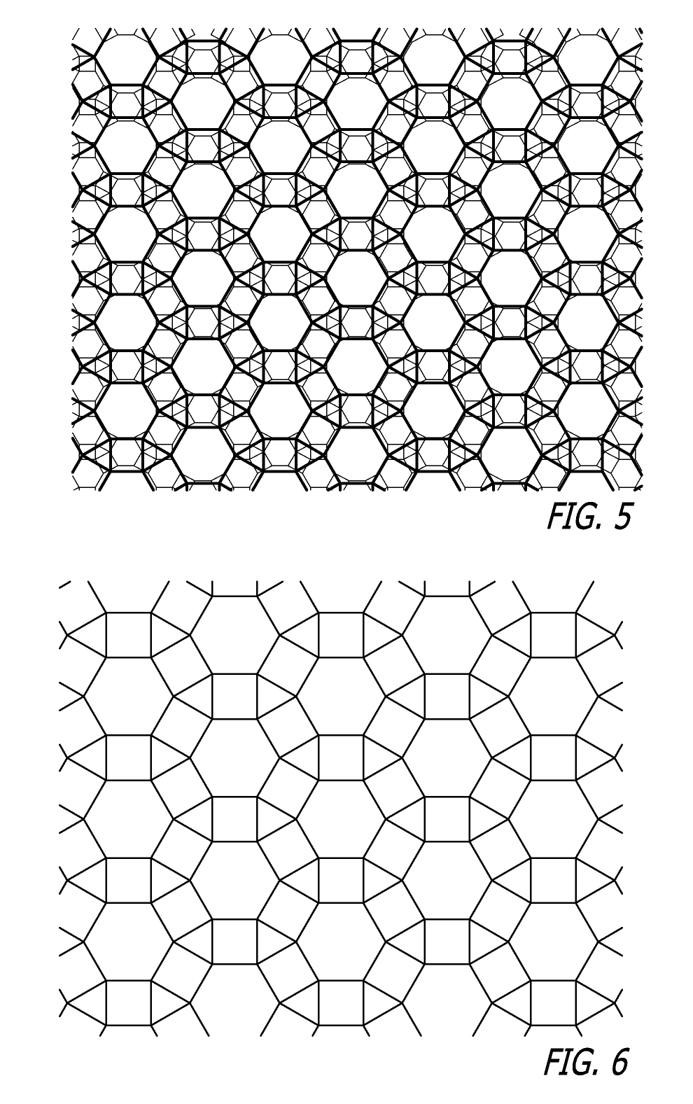

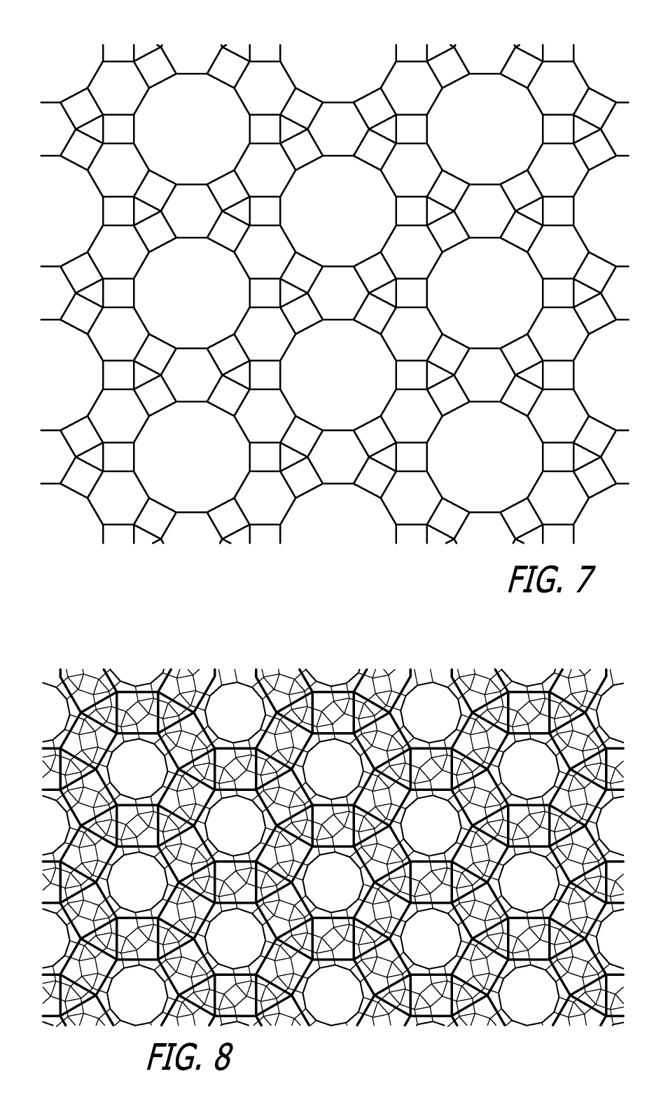

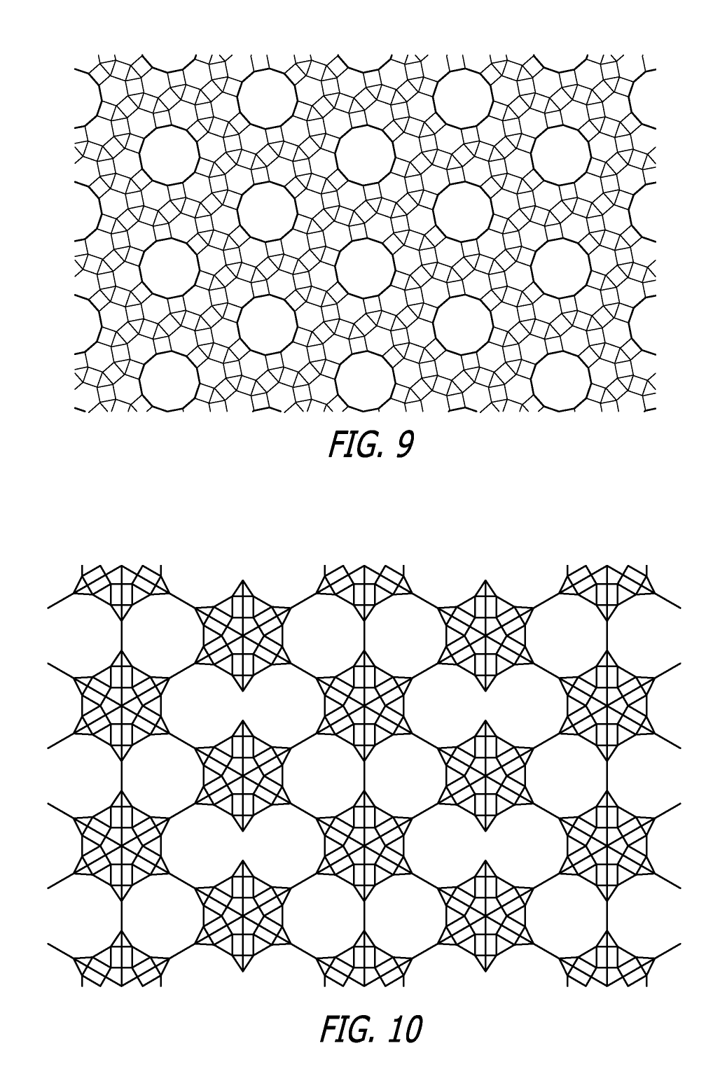

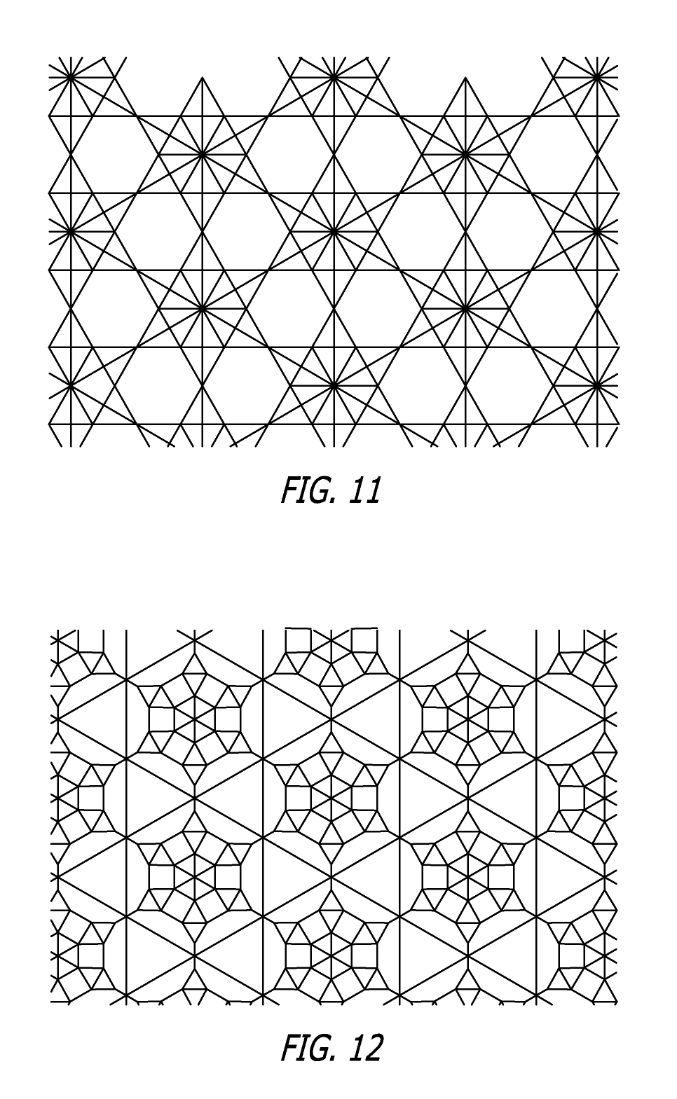

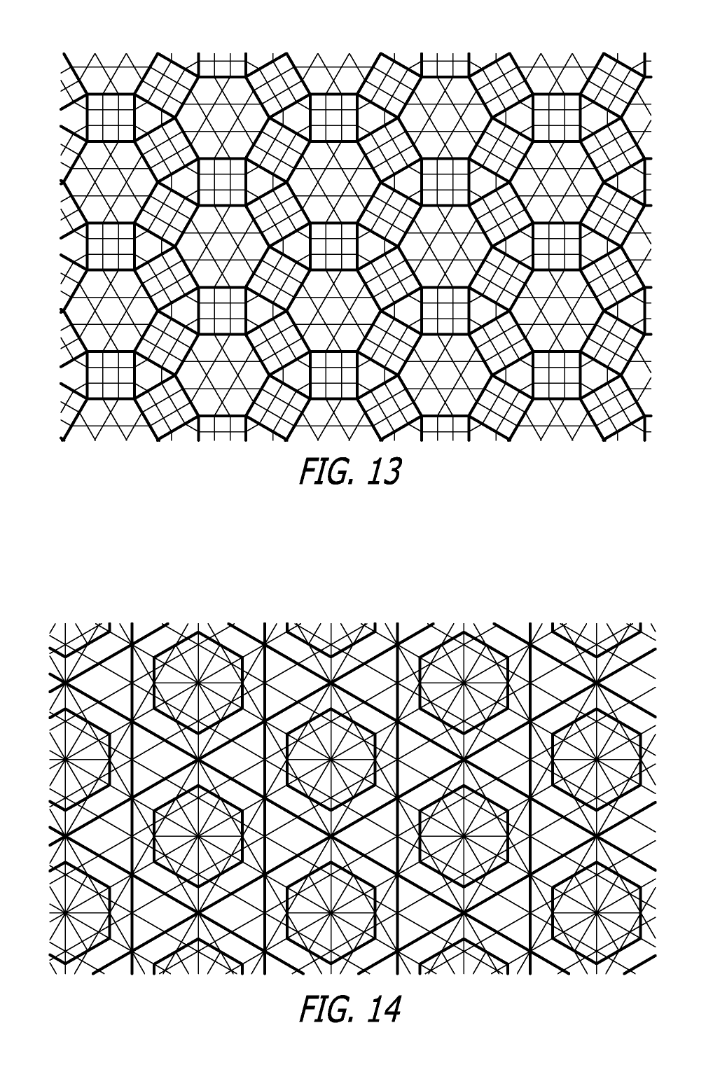

This process is illustrated by referring to FIG. 5, which shows a combined pattern generated by superimposing ingredient pattern #1, shown in FIG. 6, and ingredient pattern #2, shown in FIG. 7. Similarly, the combined pattern shown in FIG. 8 results from superimposing ingredient pattern #1, shown in FIG. 6, and ingredient pattern #2, shown in FIG. 9.

As shown by additional examples shown in the Figures, the various embodiments of the present invention may also generate very complex superimpositions. Certain combinations may also be considered special in that those shapes have a relationship defined by a ratio of edge lengths that may be used define the patterns. For example, a combined pattern such as:

| | | |
|---|---|---|
| FIG. | Description | Ratio |

| | | |
|---|---|---|
| 10 | Dodecadron within a triangle | 6.464:1 |
| 11 | Hexagon within a triangle | 3.464:1 |
| 12 | Triangle within a dodecadron | 3.232.:1 |
| 13 | Hexagon within a triangle | 3:1 |
| 14 | Hexagon within a hexagon | 1.155:1 |
| 15 | Hexagon within a hexagon within a hexagon | 1.155:1 |

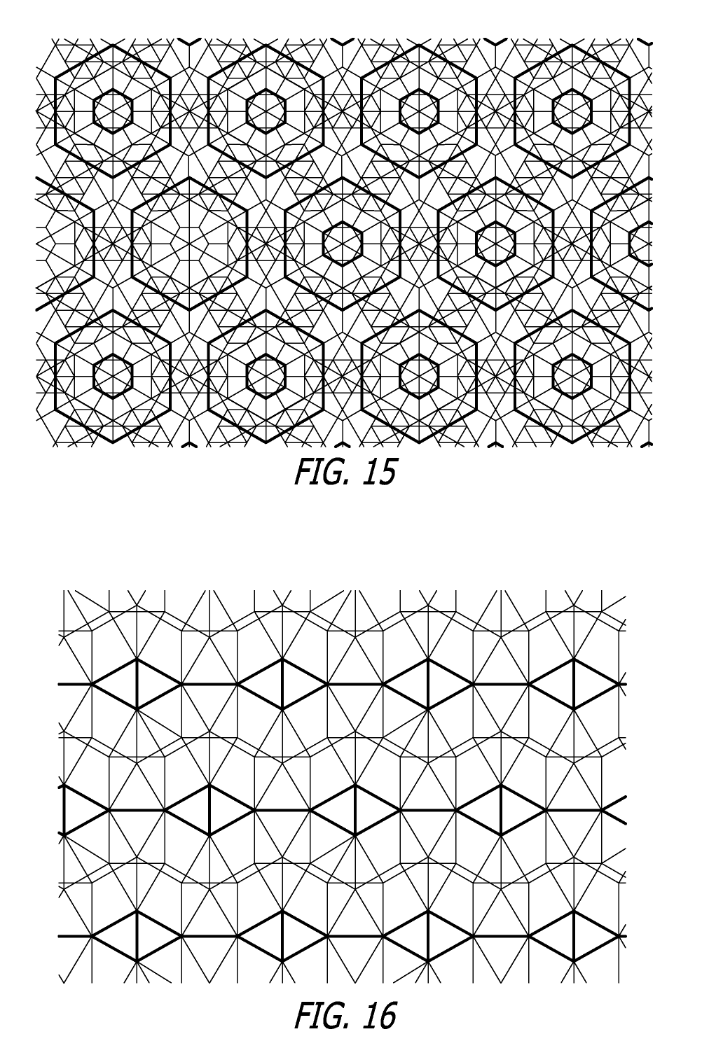

The ratios refer to the lengths of the edges of the individual patterns needed to provide the desired overlap of the patterns. Those skilled in the art will understand that edge length is proportional to the inter axial distance of each of the individual patterns. It will also be noted that more than two patterns may be superimposed, as illustrated in FIG. 15, which shows a hexagon superimposed within a hexagon superimposed in a third hexagon. Note that the ratios stay the same even though a third pattern is superimposed.

In another embodiment, a single pattern may be used to create a combined superimposed pattern. In this embodiment, the pattern is first generated, and then the user generates a second pattern, identical to the first pattern, which is then laterally shifted or displaced in a desired way. For example, the shifting may be accomplished by simply moving the pattern side to side, or up or down, a desired amount to obtain the desired effect. An example of such a combined pattern is shown in FIG. 16.

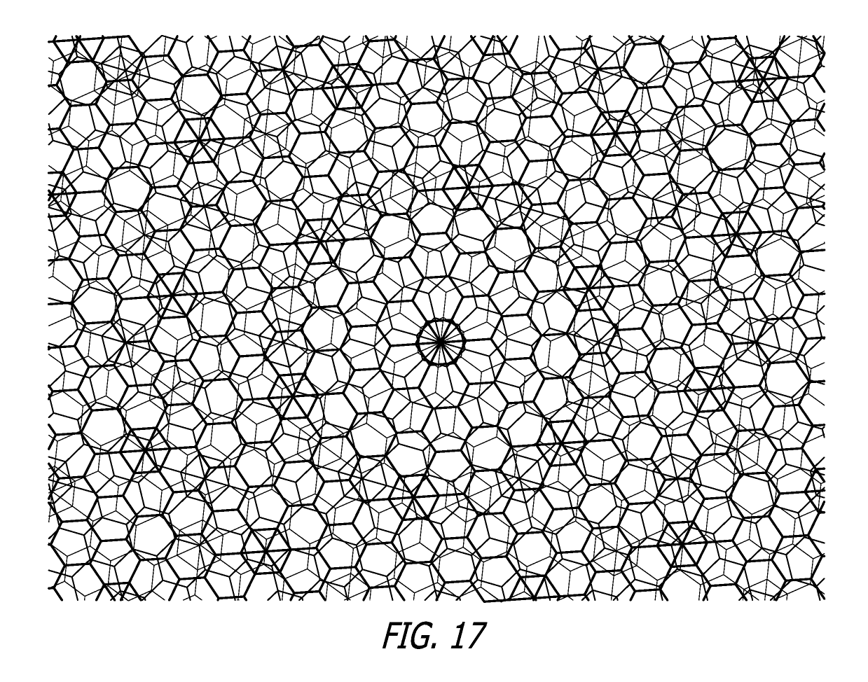

Alternatively, the subsequent patterns may be generated identically to the first pattern, and then superimposed with the first pattern by rotating the subsequent pattern in relation to the first pattern. The desired rotation may be selected by the user to produce the desired visually harmonious effect. An example of such a rotation is shown in FIG. 17.

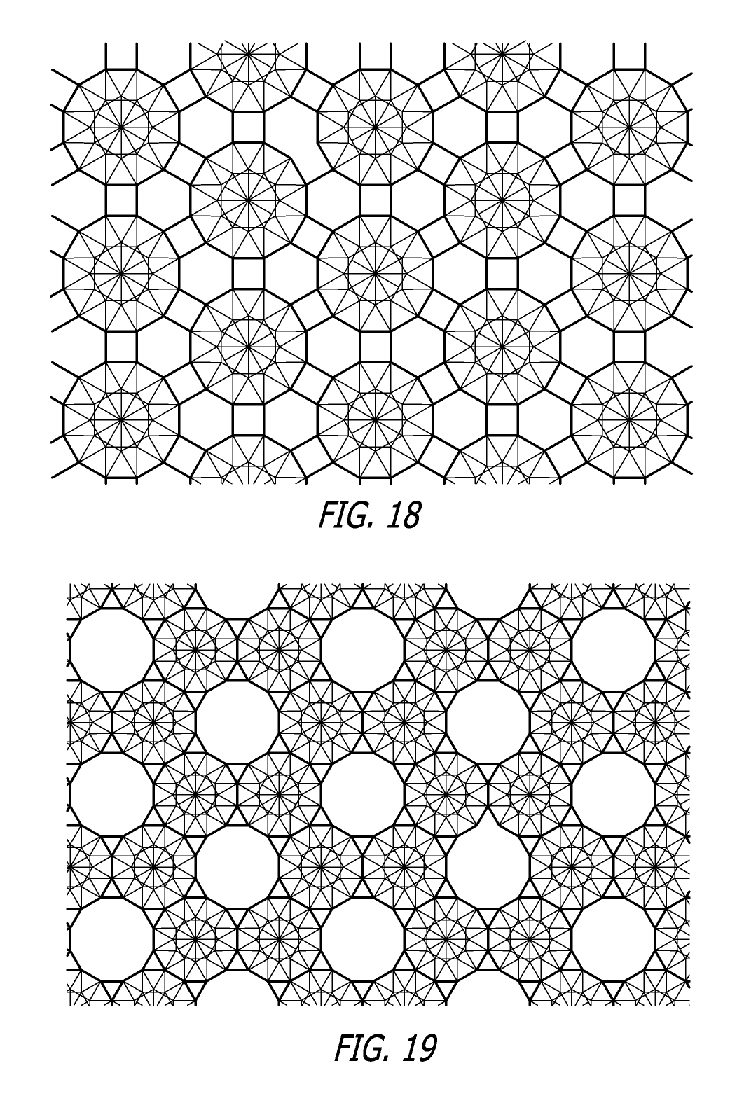

Further complex patterns may be generated, such as the 12 point star around the 6 fold axis shown in FIG. 18, and a similar pattern but in position of the 3 fold axis shown in FIG. 19.

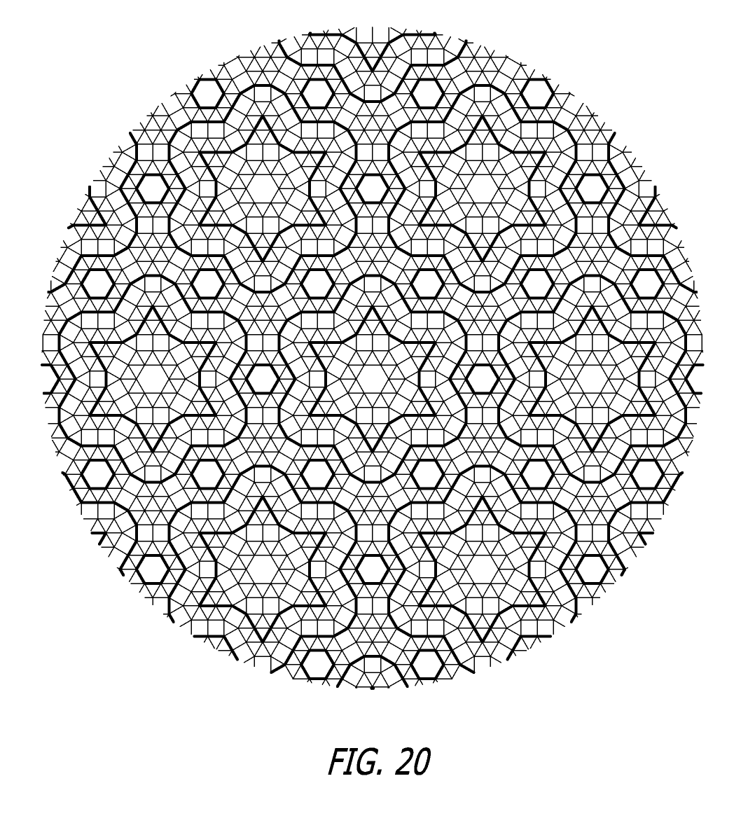

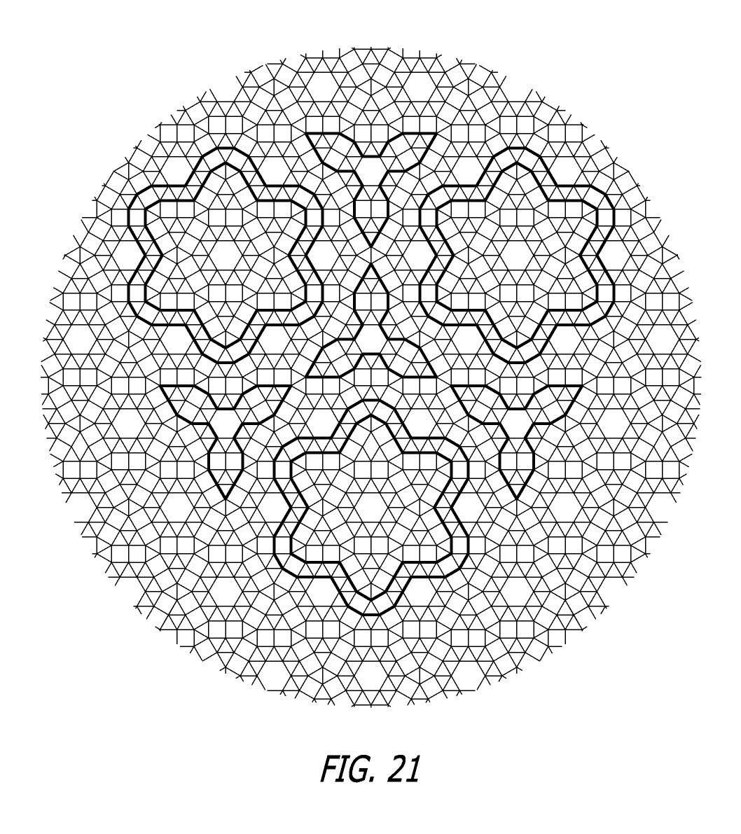

In another embodiment, the system and method of the present invention can be used to generate patterns, such as the pattern shown in FIG. 21, from which sub-patterns, such as the shapes shown in heavy lines, can be extracted. These shapes may then in turn be superimposed using the general method set forth above with other patterns to create uniquely beautiful designs. The pattern of FIG. 20 is a 6-uniform tiling. Other n-uniform tiling patterns may also be used, such as that shown in FIG. 21, which is a 5-uniform tiling. Using various of the n-uniform tilings, various patterns and sub-patterns may be generated and then superimposed on other patterns.

In yet another embodiment, the sub-patterns selected above may also be used to fill patterns generated using other tiling patterns. In this manner, a pleasing tiling pattern may be generated using two different patterns (alternatively, as stated above, the tiling pattern may be generated by displacing or rotating a single pattern), and then filled with sub-patterns formed from a superimposition that is selected to be able to be superimposed on the original superimposition to create even more beautiful and pleasing patterns.

Exemplary Uses

Various embodiments are envisioned to be within the scope of the invention, including their number beyond the current limit of six kinds of vertex, and to configure the system to also allow the user to selectively add coloration to the patterns to enhance their aesthetic effect. Such coloration would help emphasize how tilings can be regarded as different ways of allocating different shapes and sizes to cover a plane in its entirety with repeating patterns. This allows for a dashboard of whatever complexity it is desired to display any information with whatever degree of redundancy chosen. For photographers this opens up the possibility of filling the spaces with any imagery they choose in a systematic, uniform and repeatable way.

Any atomic lattice can be broken up into a series of planes which sooner or later start repeating themselves. When these are overlaid in two dimensions the result can be confusing, but, for example, if the densest plane is assigned a color to representing a distance furthest from the viewer, other colors may be assigned to each other plane in the lattice in such a way that when viewed through Chromadepth glasses the atomic lattice is perfectly represented in three dimensions. This would be advantageous in the understanding of chemistry and crystallography. Moreover, such a process would also allow artists to deconstruct the planes and reconfigure them in a way that could be considered a kind of duet with nature, to great aesthetic effect.

In another embodiment, the tilings could constitute an alphabet, or when overlapped, a language. For example, a particular tiling may be assigned to each of the phonemes that can be distinguished in all the languages of the world. This would have immediate and obvious advantages for the deaf, but may also be an agreeable alternative to conventional reading or listening to the spoken word. Variations in color and line thickness might allow us to simulate many of the subtleties of the spoken word, and still allow us to assimilate information faster than conventional reading because we are not having to narrow our attention to a single letter at a time. This could be like speed reading with a full level of accurate comprehension. In another embodiment, the letters of one or more selected alphabets may be used as motifs for tiling patterns.

The generation of the tilings and superimpositions may also be automated such that the patterns are created, or a pre-arranged sequence of patterns is selected, in response to an input or stimulus. For example, a data base of patterns could be built in such a manner as to provide a source for patterns that are selected using an algorithm having inputs selected to match certain patterns or combination of patterns to particular musical notes or phrases. Such programming could also include allowing for modulation of colors of the patterns in accordance with some characteristic of the music, such as, for example, but not limited to, the volume of the note, the timing of the note, or a particular scale being used. Such patterns could then be projected or displayed as a visual representation of the music. Obviously, many other possible uses of such a system are possible, and are contemplated to be within the scope of the present invention.

It is not only filings of regular polygons and their derivatives, such as duals, in-circles and the like, but also tiling patterns that are generated from any two dimensional image, that can be formatted and used as ingredients to create superimposition of great aesthetic value, or that can be used for visual music. In these embodiments, a fundamental region in size and shape is selected, the content desired to be extracted is selected, and then computer is controlled by the various software modules of the present invention to reassemble the fundamental region, and when necessary its minor image, into the chosen symmetry system. Only four symmetry systems, those known in the orbifold nomenclature as *632, *333, *442 and *2222 accomplish this with all boundaries of the fundamental region being minors. All of the other symmetry systems will show some discontinuity with a fully pixelated image at some boundary lines.

However if the concept of a motif to be shown against a homogeneous background is introduced, then these homogeneous backgrounds merge perfectly with each other and the full range of symmetry systems is available in the chosen format. Thus, the choice of imagery becomes vastly increased, and is, in effect, infinite. Using the various embodiments of the present invention, anyone with even a modest collection of photographic images is in a position to create their own library of tilings with which they could create their own visual music. Alternatively, given the vast number of potential images and symmetry system combinations that are available, the task of choosing which portion of the image is to be used in which symmetry system can be delegated to someone accustomed to making such choices. A relatively few images recorded on a special occasion such as a wedding could thus be turned into a visual music composition.

When taking an original source image and converting it into a tiling, the size and shape of the fundamental region is going to vary according to the symmetry system chosen. For example, symmetry system i,(o), which only utilizes translation needs 12 times more original source image content than does a *632 pattern, because of the repetition implicit in the latter. Another way of looking at this is that there are 12 possible sub regions of 1 that could be used to generate the *632 pattern. Further, if starting with*632, 11 of the copies could be removed, (including mirror images), leaving a single fundamental region occupying only one twelfth of the area. In this case it is important to understand that while this small remaining fundamental region of *632 accurately represents the symmetry system of 1, its own fundamental region includes all of the empty space.

This particular way of representing the symmetry systems with lower orders of symmetry keeps the situation from becoming overly congested, and in particular lends itself to an almost balletic choreograph between two symmetry systems that overlap and share some aspects and differ in others. While the initial objective is simply to position the tilings so that they could harmoniously interpenetrate or merge with each other, it is possible to imagine animation software that could convert one symmetry system to the other in a variety of different ways, including one which might be deemed the most direct possible. These animated transformations could be compared to the steps in classical ballet, and each sequence would correspond to a unique choreography, which in turn could be performed by a wide variety of dancers.

The various embodiments of the present invention may also be used to create tiling patterns that could be used to develop a kind of alphabet, and ultimately a language. Such development would involve a multitude of choices, and ultimately mapping the tilings to an existing alphabet. Presently, the roman alphabet exists and is familiar to a considerable portion of the planet's population, and other alphabets are familiar to other portions of the population. The letters of an alphabet, such as the roman alphabet, when placed in the context of a fundamental region, can be assembled into each of the possible symmetry systems, and in many cases form beautiful designs. The smaller and more centrally placed the letters, the more the human brain will retain its traditional perception of those letters, whereas the closer the letters approach or touch the boundaries of the pattern, or even extend beyond the boundaries of the pattern, the more likely the brain is to perceive those letters as abstract patterns.

The advantages of utilizing the letters of the alphabet as motifs in a pattern is that the brain's familiarity with them facilitates nomenclature and recognition. Besides the formatting steps set forth above, some embodiments could also incorporate a selection of a particular font to be used in creating the motifs of the patterns. This makes available an enormous repertoire of possibilities while using set of parameters, such as symmetry system, shape, rotation and scale, with which the creator of the pattern is relatively familiar.

To those who believe the creative process has a large evolutionary component depending on the power of selection, such a process makes a very attractive field of possibilities for the creation of visual music. In fact, it is possible to imagine each existing image of a given symmetry system to be potentially related to any other of the remaining 16 symmetry systems, and to be able to call up simultaneously thumb nail images of these possibilities. Such a system is advantageous in that a visual music composer would only have to make a series of successive choices to create a unique expression of his preferences while ensuring that nothing too discordant is displayed.

In another embodiment, the system and methods described above may be used to create images that are used in a game, such as a game bearing some relationship to scrabble, but which allows players to assemble ingredients much like letters are put together in scrabble, but with periodic tilings being the goal rather than words.

In other embodiments, images and patterns could be created and used in gambling machines. For example, a gambling machine such as a slot machine typically displays a number of numbers, images, patterns or other visual devices to a user. When those numbers and the like are aligned in certain manner, the machine may reward the user. Using the case of a gambling machine that displays fruit to the user, a linear sequence of fruit could be extended to patterns in two dimensions. For example, the format of squares broken down to 8 small fundamental regions allows a motif and its minor image to occupy the same shaped fundamental region, so a spin could bring up an image or its enantiomorphic mirror image, leading to any one of the 12 possibilities of this format being displayed to the user. The larger the field of the potential tiling the less likely any tiling than 1 would be likely to occur, leading to higher odds.

It will also be understood that the present invention includes various embodiments that include possible harmonious juxtapositions and mergings applied to lateral transitions from one tiling pattern to another tiling pattern. Large scale tiling patterns gain interest when there is not too much precise repetition of the pattern. However, it is necessary to make transitions that are smooth and not too abrupt, which is ensured by tilings that share edge length and IAD. If needed, the edge length of a pattern can be adjusted so that the IADs of two contiguous tilings have an uninterrupted sequence of centers of rotational symmetry. Similar possibilities exist for fabric design where different patterns can be joined with a blended area connecting disposed between adjacent patterns. Another way of thinking of this is to imagine a juxtaposed image of all of the tiling patterns desired to be incorporated into an end products and then varying the proportions of the different ingredients in different areas of the end product.

While the above exemplary embodiments of the present invention have been described with regards to the creation of two-dimensional superimposed patterns, it will be understood that superimpositions created in three dimensions are also possible, and that their creation is intended to fall within the scope of the intended invention.

While several particular forms of the invention have been illustrated and described, it will be apparent that various modifications can be made without departing from the spirit and scope of the invention.

I claim:

1. A system for generating superimposed patterns, comprising:
a processor, responsive to input from a user, programmed using appropriate hardware and software commands, to
generate a first pattern having a plurality of elements from the user's input,
generate a second pattern having a plurality of second elements from the user's input,
determine a first center point representing a selected axis of rotation of a first element of the first pattern,
determine a second center point representing the same axis of rotation of an adjacent element of the first pattern,
calculate an inter axial distance for the for first pattern from the first and second center points of the first pattern,
determine a first center point representing a selected axis of rotation of a first element of the second pattern,
determine a second center point representing the same axis of rotation of an adjacent element of the second pattern,
calculate an inter axial distance for the for second pattern from the first and second center points of the second pattern,
align the first center point of the second pattern with the first center point of the first pattern,
rotate at least one of the first pattern and the second pattern such that a line joining the first and second center points of the second pattern overlaps a line joining the first and second center points of the first pattern,
scale at least one of the first and second patterns such that the inter axial distance of the first pattern is substantially equal to the inter axial distance of the second pattern, and
produce an output representing the superposition of the first and second patterns.

2. The system of claim 1, wherein the second pattern is the same pattern as the first pattern, but displaced by a selected value.

3. The system of claim 1, wherein the second pattern is the same pattern as the first pattern, but rotated in relation to the first pattern by a selected amount.

4. The system of claim 1, wherein the processor is also programmed to:
select, in response to input from the user, a sub-pattern of either the first or second patterns, and superimpose that sub-pattern on a selected one or both of the first and second patterns.

5. The system of claim 1, further comprising a data base of superimposed patterns.

6. The system of claim 1, wherein the processor is further programmed to respond to a user input to generate at least one superimposed pattern.

7. The system of claim 5, wherein the processor is further programmed to respond to a user input to select a superimposed pattern from the data base of superimposed patterns and output the superimposed pattern.

8. The system of claim 7, wherein the input is a sound.

9. The system of claim 7, wherein the input is music.

10. The system of claim 7, wherein the input is speech.

11. The system of claim 6, wherein the input is a sound.

12. The system of claim 6, wherein the input is music.

13. The system of claim 6, wherein the input is speech.

14. A method for superimposing tiling patterns in response to a user input, comprising:
generating a first pattern having a plurality of elements from the user's input;
generating a second pattern having a plurality of second elements from the user's input;
determining a first center point representing a selected axis of rotation of a first element of the first pattern;
determining a second center point representing the same axis of rotation as that selected for the first element of an adjacent element of the first pattern;
calculating an inter axial distance for the for first pattern from the first and second center points of the first pattern;
determining a first center point representing a selected axis of rotation of a first element of the second pattern;
determining a second center point representing the same axis of rotation as that selected for the first element of an adjacent element of the second pattern;
calculating an inter axial distance for the for second pattern from the first and second center points of the second pattern;
aligning the first center point of the second pattern with the first center point of the first pattern;
rotating at least one of the first pattern and the second pattern such that a line joining the first and second center points of the second pattern overlaps a line joining the first and second center points of the first pattern;
scaling at least one of the first and second patterns such that the inter axial distance of the first pattern is substantially equal to the inter axial distance of the second pattern; and
producing an output representing the superposition of the first and second patterns.

15. The method of claim 14, wherein the user's input includes selecting a symmetry system to be used for generating the first or second patterns.

16. A method for superimposing periodic patterns of repeating elements in response to a user input, comprising:
selecting a symmetry system to be used to generate a first pattern of repeating elements;
specifying a shape and orientation of the repeating elements of the first pattern;
generating the first pattern;
selecting a symmetry system to be used to generate a second pattern of repeating elements;
specifying a shape and orientation of the repeating elements of the second pattern;
generating the second pattern;
determining a first center point representing a selected axis of rotation of a first element of the first pattern;
determining a second center point representing the same axis of rotation of an adjacent element of the first pattern as that selected for the first element of the first pattern;
calculating an inter axial distance for the for first pattern from the first and second center points of the first pattern;
determining a first center point representing a selected axis of rotation of a first element of the second pattern;
determining a second center point representing the same axis of rotation of an adjacent element of the second pattern as that selected for the first element of the second pattern;
calculating an inter axial distance for the for second pattern from the first and second center points of the second pattern;
aligning the first center point of the second pattern with the first center point of the first pattern;
rotating at least one of the first pattern and the second pattern such that a line joining the first and second center points of the second pattern overlaps a line joining the first and second center points of the first pattern;
scaling at least one of the first and second patterns such that the inter axial distance of the first pattern is substantially equal to the inter axial distance of the second pattern; and
producing an output representing the superposition of the first and second patterns.
